(19) United States
(12) Patent Application Publication
(10) Pub. No.: US 2025/0115764 A1
(43) Pub. Date: Apr. 10, 2025

(54) METHOD FOR BLUING ANTHOCYANIN

(71) Applicant: CHINA AGRICULTURAL UNIVERSITY, Beijing (CN)

(72) Inventors: Xiaojun LIAO, Beijing (CN); Peiqing YANG, Beijing (CN); Wenxin WANG, Beijing (CN); Zhenzhen XU, Beijing (CN); Yongtao WANG, Beijing (CN)

(21) Appl. No.: 18/981,602

(22) Filed: Dec. 15, 2024

Related U.S. Application Data
(63) Continuation of application No. PCT/CN2023/125919, filed on Oct. 23, 2023.

(30) Foreign Application Priority Data
Feb. 21, 2023 (CN) 202310144108.7

(51) Int. Cl. C09B 61/00; A23L 5/43; C09B 67/44

(52) U.S. Cl. CPC C09B 61/00; A23L 5/43; C09B 67/0083

(57) ABSTRACT

The present application provides a method for bluing anthocyanin, including: mixing anthocyanin with a protein to obtain a mixed solution; and bluing the anthocyanin through standing treatment of the mixed solution. The method includes no high hydrostatic pressure treatment. A concentration of the anthocyanin in the mixed solution ranges from 0.05 mM to 0.2 m. The anthocyanin is cyanidin-3-glucoside, the protein is selected from human serum albumin or lysozyme, a final concentration of the human serum albumin, if present, in the mixed solution ranges from 0.1 mM to 2 mM, and a final concentration of the lysozyme, if present, ranges from 0.8 mM to 1.5 mM. Alternatively, the anthocyanin is malvidin-3-glucoside, the protein is selected from human serum albumin or bovine serum albumin, and the final concentration ranges from 0.1 mM to 0.5 mM. A pH value of the mixed solution ranges from 5.0 to 9.0.

### CROSS-REFERENCE TO RELATED APPLICATIONS

This application is a continuation of International Application No. PCT/CN2023/125919, filed on Oct. 23, 2023, which claims priority to Chinese Patent Application No. 202310144108.7, filed on Feb. 21, 2023. The disclosures of the aforementioned applications are hereby incorporated by reference in their entireties.

### FIELD

The present disclosure relates to the field of food products. Particularly, the present disclosure provides a method for bluing anthocyanin.

### BACKGROUND

Anthocyanins refer to a kind of water-soluble natural pigments in fruits and vegetables, which have many physiological functions such as anti-oxidation, anti-inflammatory, antibacterial and diabetes prevention, thereby having great application prospects in food. At different pH values, anthocyanins may exhibit different colored and colorless structures, between which a complex inversion equilibrium exists. Thus, the color of anthocyanins changes with a change of pH. Specifically, anthocyanin appears red under acidic conditions and purple under neutral and basic conditions.

Currently most blue-colored foods, pharmaceuticals, and cosmetics are made from synthetic blue pigments. These chemically synthesized pigments may have potential problems such as harm to human health and adverse effects on sustainable production. Therefore, it is urgent to find a natural, edible and green and environment-friendly blue pigment. If anthocyanins can turn blue for use as blue pigments, the application fields of anthocyanins will be greatly broadened and the value thereof will be significantly enhanced.

### SUMMARY

In one aspect, the present disclosure provides a method for bluing anthocyanin. According to embodiments of the present disclosure, the method includes: mixing anthocyanin with a protein to obtain a mixed solution, and bluing the anthocyanin through standing treatment of the mixed solution.

In another aspect, the present disclosure provides a method for bluing anthocyanin. According to an embodiment of the present disclosure, the method includes: mixing anthocyanin with a protein in a buffer solution with a pH value of 7.0, to obtain a mixed solution; and allowing the mixed solution to stand at 25° C. in the dark for 60 min. A concentration of the anthocyanin in the mixed solution is 0.05 mM. The anthocyanin is cyanidin-3-glucoside, the protein is selected from human serum albumin or lysozyme, a concentration of the human serum albumin, if present, in the mixed solution is 0.2 mM, and a concentration of the lysozyme, if present, in the mixed solution is 1 mM. Alternatively, the anthocyanin is malvidin-3-glucoside, the protein is selected from human serum albumin or bovine serum albumin, and a concentration of the human serum albumin or the bovine serum albumin in the mixed solution is 0.2 mM.

In another aspect, the present disclosure provides a method of preparing an anthocyanin preparation. According to an embodiment of the present disclosure, the method includes the method for bluing anthocyanin as described above.

Additional aspects and advantages of the present disclosure will be set forth in part in the description which follows and, in part, will be obvious from the description, or may be learned by practice of the present disclosure.

### BRIEF DESCRIPTION OF THE DRAWINGS

The foregoing and/or additional aspects and advantages of the present disclosure will become apparent and readily appreciated from the following description of the embodiments, taken in conjunction with the accompanying drawings.

FIG. 1 shows visible absorption spectra of the solution of anthocyanin alone and the solutions of anthocyanin added with different proteins according to Example 1;

FIG. 2 is a representation of a CIE Lab color model of the solution of anthocyanin alone and the solutions of anthocyanin added with different proteins according to Example 1 (merely indicating a*, b*, L* fixed at 70);

FIG. 3 shows visible absorption spectra of the solution of anthocyanin alone and the solutions of anthocyanin added with human serum albumin according to Example 2;

FIG. 4 is a diagram illustrating a change in absorbance at the maximum absorption wavelength (608 nm) of the solution of anthocyanin added with human serum albumin according to Example 2;

FIG. 5 is a diagram illustrating a change in absorbance at the maximum absorption wavelength during 7 days of storage of the solution of anthocyanin alone and the solution of anthocyanin added with human serum albumins according to Example 2;

FIG. 6 shows visible absorption spectra of solutions of different anthocyanins and solutions of different anthocyanins added with different proteins according to Example 3; and

FIG. 7 is a representation of a CIE Lab color model for the solutions of different anthocyanins and the solutions of different anthocyanins added with different proteins according to Example 3 (merely indicating a*, b*, L″ fixed at 70).

### DETAILED DESCRIPTION

The present disclosure aims to solve, at least to some extent, at least one of the technical problems existing in the related art. To this end, the present disclosure provides a method for bluing anthocyanin, a method for preparing an anthocyanin product, and an anthocyanin product. With the method of the present disclosure, anthocyanins can be blued without introducing metal ions and have stable color. Thus, shelf life can be prolonged, food quality can be improved, and application value is high. The method is simple and rapid, without requiring high hydrostatic pressure treatment. Therefore, the method is suitable for large-scale production.

In one aspect, the present disclosure provides a method for bluing anthocyanin. According to embodiments of the present disclosure, the method includes: mixing anthocyanin with a protein to obtain a mixed solution, and bluing the anthocyanin through standing treatment of the mixed solution. The method includes no high hydrostatic pressure treatment. A concentration of the anthocyanin in the mixed solution ranges from 0.05 mM to 0.2 mM. The anthocyanin is cyanidin-3-glucoside, and the protein is selected from human serum albumin or lysozyme. A concentration of the human serum albumin, if present, in the mixed solution ranges from 0.1 mM to 2 mM, and a concentration of the lysozyme, if present, in the mixed solution is 0.8 mM to 1.5 mM. Alternatively, the anthocyanin is malvidin-3-glucoside, and the protein is selected from human serum albumin or bovine serum albumin. A concentration of the human serum albumin or bovine serum albumin in the mixed solution ranges from 0.1 mM to 0.5 mM. A pH value of the mixed solution ranges from 5.0 to 9.0.

Anthocyanins widely exist in the cell sap of flowers, fruits, stems, leaves and root organs of plants. They are flavonoid compounds formed by anthocyanidins linked to sugar moieties through glycosidic bonds. These compounds are characterized by a pH-dependent multistate system based on flavylium cation, allowing them to appear different colors of red and purple at different pH.

When studying how anthocyanins turn blue, the inventors found that certain anthocyanins can turn blue through mixing and standing treatment when interacting with a specific protein. For example, cyanidin-3-glucoside can turn blue when interacting with human serum albumin or lysozyme, but cannot turn blue when interacting with bovine serum albumin; malvidin-3-glucoside can turn blue when interacting with human serum albumin or bovine serum albumin; and pelargonidin-3-glucoside cannot turn blue when interacting with human serum albumin or bovine serum albumin.

Further, the inventors have found that the color change effect of anthocyanins is also affected by the mixing concentration of the protein and anthocyanins. For example, cyanidin-3-glucoside does not turn blue with 0.2 mM lysozyme, but turns blue with 1 mM lysozyme. To this end, the inventors obtained various concentration combinations of anthocyanin and the corresponding protein through extensive experimental optimization.

In addition, the inventors have found that the color change effect of anthocyanins is significantly affected by the pH value of the system in which anthocyanin and protein are mixed and subjected to standing treatment. When the pH value of the system is excessively low or high, anthocyanins do not turn blue. Furthermore, through extensive experimental optimization, the inventors obtained the pH value of the system at the time of mixing treatment. When the pH value ranges from 3 to 5, the anthocyanins can be quickly hydrated and discolored. When the pH value is greater than 9, the anthocyanins can be rapidly degraded. The anthocyanins' color is relatively stable when the pH value is weakly acidic or neutral. Under strong acid condition (pH<3), anthocyanins may turn to red flavylium cation, and the protein may be denatured. In this case, they cannot be combined to turn blue.

With the method according to the embodiments of the present disclosure, anthocyanins can be blued without introducing metal ions and have stable color. Thus, shelf life can be prolonged, food quality can be improved, and application value is high. The method is simple and rapid, without requiring high hydrostatic pressure treatment. Therefore, the method is suitable for large-scale production.

According to the embodiments of the present disclosure, the above-mentioned method for bluing anthocyanin may further have the following additional technical features.

According to an embodiment of the present disclosure, the anthocyanin cyanidin-3-glucoside, the protein is selected from human serum albumin or lysozyme, a concentration of the human serum albumin, if present, in the mixed solution ranges from 0.1 mM to 0.3 mM, and a concentration of the lysozyme, if present, in the mixed solution ranges from 0.9 mM to 1.2 mM. According to an embodiment of the present disclosure, the anthocyanin is malvidin-3-glucoside, the protein is selected from human serum albumin or bovine serum albumin, and a concentration of the human serum albumin or the bovine serum albumin in the mixed solution ranging from 0.1 mM to 0.3 mM.

According to an embodiment of the present disclosure, the mixing treatment includes: mixing the anthocyanin and the protein in a buffer. The buffer is selected from a phosphate buffer, a citrate buffer, a MOPS buffer, a Tris-HCl buffer, a CHES buffer, a MES buffer, or a HEPES buffer. The pH value of the solution ranges from 5.0 to 9.0. These conditions are optimal for proteins and anthocyanins and can quickly and efficiently turn anthocyanins into blue color with strong color and structural stability.

According to an embodiment of the present disclosure, the standing treatment includes standing at 0 to 40° C. for 10 minutes to 180 minutes in the dark. Preferably, the temperature of the standing treatment ranges from 20 to 30° C., the duration thereof ranges from 60 to 180 min. Through a large number of experiments, the inventors obtained the above-mentioned preferable reaction conditions, which allow the anthocyanins to turn into blue colors with strong color and structural stability. If the standing treatment is performed at an excessively high temperature or for an excessively long time, hydration/degradation of anthocyanins may likely occur. If the standing treatment is performed at an excessively low temperature or for an excessively short time, it is not conducive to the stability of blue color of the anthocyanins.

In another aspect, the present disclosure provides a method for bluing anthocyanin. According to an embodiment of the present disclosure, the method includes: mixing anthocyanin with a protein in a buffer solution with a pH value of 7.0, to obtain a mixed solution; and allowing the mixed solution to stand at 25° C. in the dark for 60 min. A concentration of the anthocyanin in the mixed solution is 0.05 mM. The anthocyanin is cyanidin-3-glucoside, the protein is selected from human serum albumin or lysozyme, a concentration of the human serum albumin, if present, in the mixed solution is 0.2 mM, and a concentration of the lysozyme, if present, in the mixed solution is 1 mM. Alternatively, the anthocyanin is malvidin-3-glucoside, the protein is selected from human serum albumin or bovine serum albumin, and a concentration of the human serum albumin or the bovine serum albumin in the mixed solution is 0.2 mM. With the method according to the embodiment of the present disclosure, anthocyanins can be rapidly and efficiently blued with strong color and structural stability. The method is simple and rapid, without requiring high hydrostatic pressure treatment. Therefore, the method is suitable for large-scale production.

In another aspect, the present disclosure provides a method of preparing an anthocyanin preparation. According to an embodiment of the present disclosure, the method includes the method for bluing anthocyanin as described above. Thus, blue anthocyanins can be obtained using the method for bluing anthocyanin as described above, and they can be used as raw materials or additives to prepare anthocyanin preparations.

### BENEFICIAL EFFECTS

In the present disclosure, red/purple anthocyanins can turn blue and the color can be intensified through the interaction between anthocyanins and proteins, and the color and structural stability during storage are enhanced, which is conducive to prolonging the shelf life of foods. Moreover, the existing natural edible blue pigments are scarce. With the method of the present disclosure, the anthocyanins can appear blue without introducing metal ions, and thus they can be used for the production of products and improve food quality.

Additional aspects and advantages of the present disclosure will be set forth in part in the description which follows and, in part, will be obvious from the description, or may be learned by practice of the present disclosure.

The embodiments of the present disclosure will be explained with reference to the following examples. It will be understood by those skilled in the art that the following examples are merely intended to explain the present disclosure, rather than limiting the scope of the present disclosure. Where specific techniques or conditions are not specified in the examples, they are performed according to techniques or conditions described in the literature in the art or according to the product description. The reagents or instruments used are conventional products that can be obtained commercially without indicating the manufacturer.

Materials and instruments of examples: cyanidin-3-glucoside was purchased from Shanghai Tauto Biotech Co., Ltd.; pelargonidin-3-glucoside was purchased from Shanghai yuanye Bio-Technology Co., Ltd.; malvidin-3-glucoside was purchased from SHANGHAI ZZBIO Co., Ltd.; proteins and buffer salts were purchased from Sigma-Aldrich; and the ultraviolet-visible spectrophotometer was a Shimadzu UV-1800.

### Example 1

In Example 1, the effects of addition of human serum albumin (HSA), lysozyme (LYS), bovine serum albumin (BSA), bovine milk β-lactoglobulin (BLG) on the color of anthocyanin (cyanidin-3-glucoside) were evaluated.
(1) A solution of anthocyanin (cyanidin-3-glucoside) with a concentration of 5 mM was prepared in hydrochloric acid at pH of about 2. Solutions of each of HSA, LYS, BSA, and BLG with a concentration of 0.2 mM, and a solution of LYS with a concentration of 1 mM were prepared in 20 mM MOPS buffer (pH 7.0), respectively.
(2) The above-mentioned solutions were preheated to 25° C., 20 μL of the anthocyanin solution was mixed with 2 mL of the protein solution, and the pH value of the resulting mixed solution was 7.0. As the control group, 20 μL of the anthocyanin solution and 2 mL of MOPS buffer were taken to mix well. All the mixtures stood at 25° C. for 60 min in the dark.

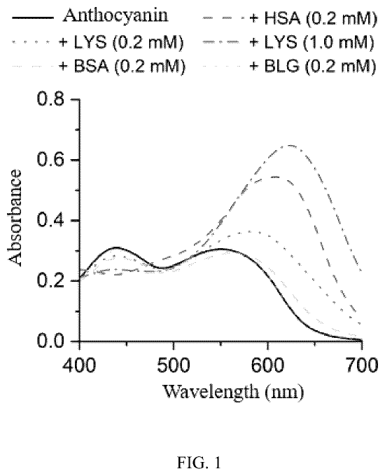

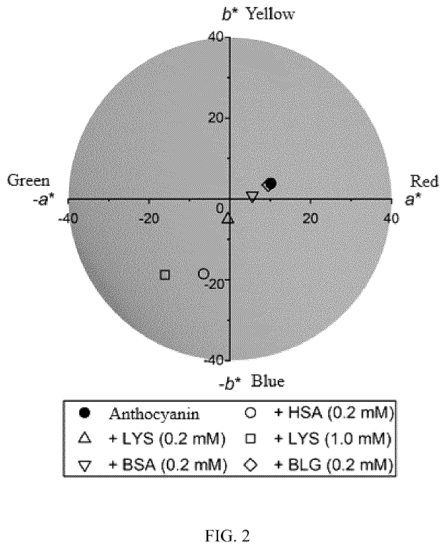

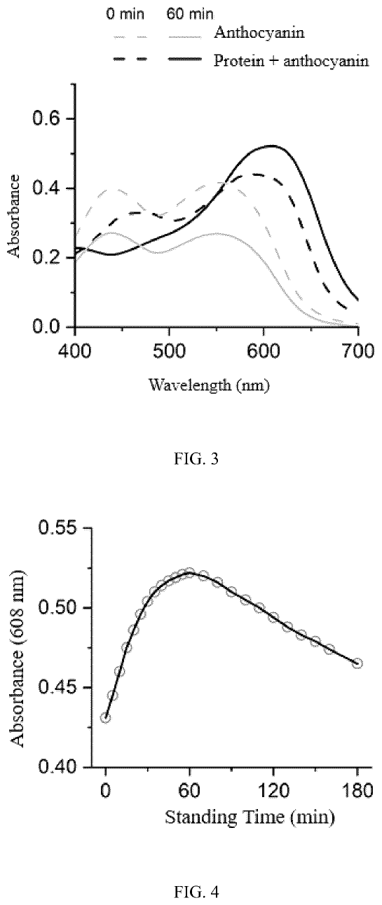

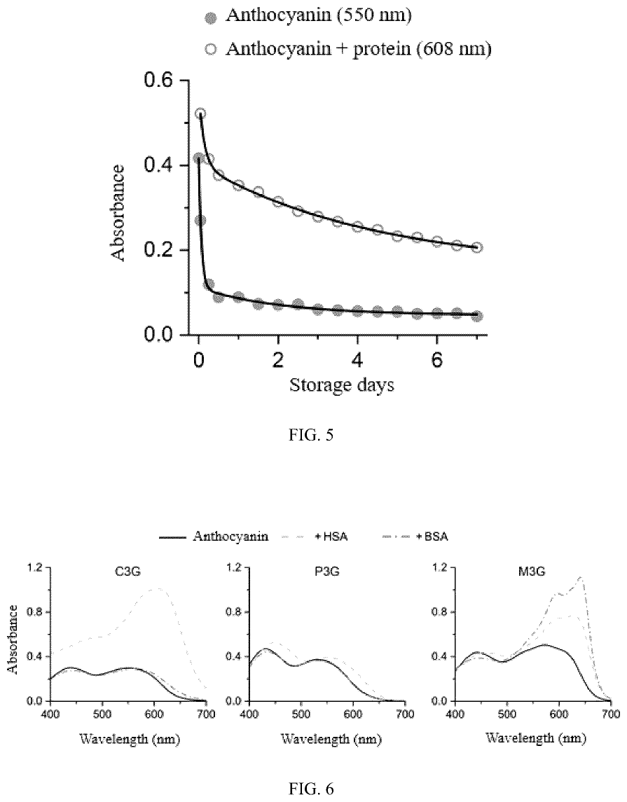

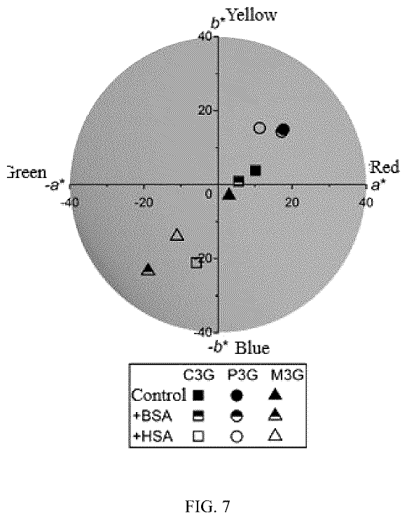

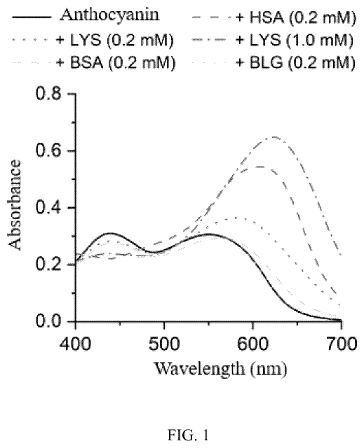

As shown in FIG. 1, the maximum absorption wavelength (λₘₐₓ) of the solution of anthocyanin alone (0.05 mM) was 550 nm, at which the solution was purple-red. The addition of BSA (0.2 mM) and BLG (0.2 mM) did not result in a significant change in the visible absorption spectrum of the solution, and had insignificant effect on the color of the solution. The addition of HSA (0.2 mM) and LYS (0.2 mM) resulted in red shifts of 58 nm and 32 nm, shifting the maximum absorption wavelength (λₘₐₓ) of the solution to 608 nm and 582 nm, respectively. When increasing the concentration of LYS to 1 mM, the maximum absorption wavelength (λₘₐₓ) of the solution shifted to 623 nm by a red shift of 73 nm. In general, λₘₐₓ>600 nm is an indicator that the solution turns blue. At the same time, the absorbance of the solution also increases with the addition of protein, which means that the color of the solution increases.

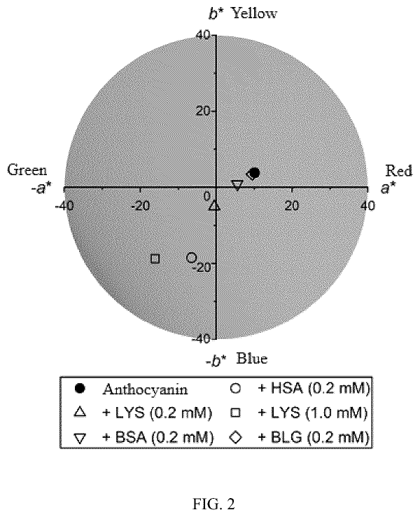

The color of the sample represented by the CIE Lab color model was calculated based on the visible absorption spectra, as shown in Table 1 and FIG. 2. The addition of BSA (0.2 mM) and BLG (0.2 mM) did not result in a significant change in the color of the solution. The addition of HSA (0.2 mM) and LYS (0.2 mM) resulted in a decrease in both a* and b* of the solution to negative values, resulting in a decrease in the red contribution to the color, such that the solution turned to a blue color. Such an effect was significantly enhanced by increasing the concentration of LYS to 1.0 mM. By comparing the color difference between the control group and the above-described groups, it can be known that an obvious color change can be observed after adding human serum albumin or lysozyme.

TABLE 1
Representation of the CIE Lab color model for the
solution of anthocyanin alone and the solutions
of anthocyanin added with different proteins

| Group | L* | a* | b* | ΔE |
|---|---|---|---|---|
| Anthocyanin | 79.41 | 10.16 | 3.85 | — |
| +HSA (0.2 mM) | 69.86 | −6.53 | −18.53 | 29.51 |
| +LYS (0.2 mM) | 75.55 | −0.51 | −5.04 | 14.41 |
| +LYS (1.0 mM) | 69.86 | −16.08 | −18.82 | 35.97 |
| +BSA (0.2 mM) | 79.42 | 5.55 | 0.84 | 5.50 |
| +BLG (0.2 mM) | 79.69 | 9.51 | 3.46 | 0.81 |

### Example 2

In Example 2, the effects of addition of human serum albumin (HSA) on the color and stability of anthocyanin were evaluated. The specific steps are described below.
(1) A solution of anthocyanin (cyanidin-3-glucoside) with a concentration of 5 mM was prepared in hydrochloric acid at pH of about 2. A solution of HSA with a concentration of 0.2 mM was prepared in 20 mM MOPS buffer (pH 7.0).
(2) The above two solutions were preheated to 25° C. 20 μL of the anthocyanin solution was mixed with 2 mL of the HSA solution, and the pH value of the resulting mixed solution was 7.0. 20 μL of the anthocyanin solution and 2 mL of MOPS buffer were taken to mix well as the control group. The mixture stood at 25° C. for 180 min in the dark. The visible absorption spectrum was measured at intervals.
(3) The above solutions were stored at 25° C. for 7 days, and the visible absorption spectrum was measured at intervals of 12 hours.

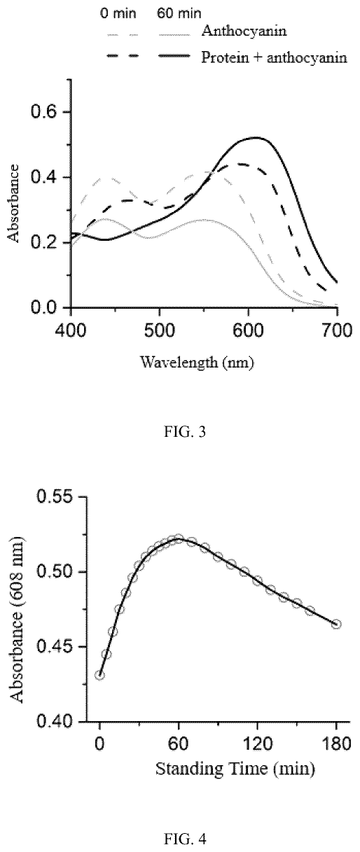

As shown in FIG. 3, the maximum absorption wavelength of the solution of anthocyanin alone (0.05 mM) was 550 nm, at which the solution was purple-red. The absorbance decreased and the color faded after standing for 60 min due to hydration and degradation of anthocyanins. However, after adding 0.2 mM HSA and standing for 60 min, the maximum absorption wavelength of anthocyanin was red-shifted to 608 nm, and the absorbance increased, at which time the solution turned blue. As shown in FIG. 4, a blue complex was generated within the first 60 min due to the interaction of the anthocyanin and protein, the absorbance at 608 nm gradually increased, and the blue color continued to deepen. Thereafter, the absorbance gradually decreased due to hydration/degradation of anthocyanins.

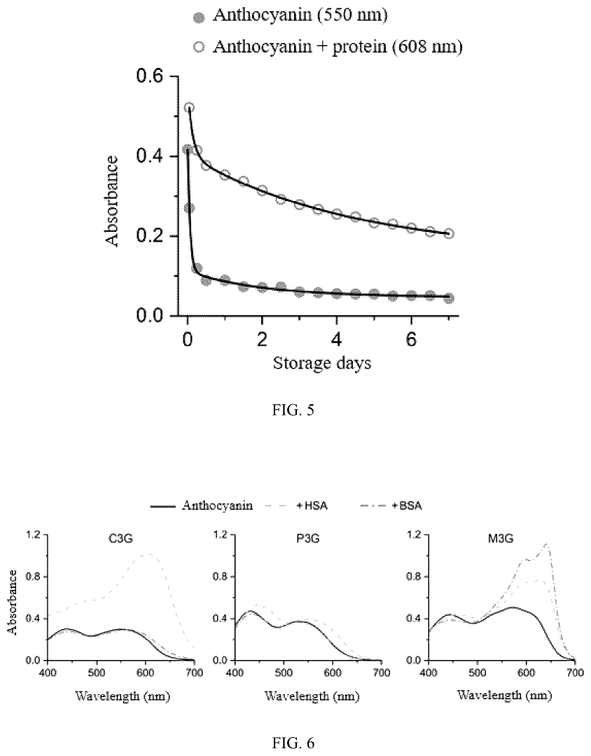

As shown in FIG. 5, during 7 days of storage, the absorbance at the maximum absorption wavelength of both solutions decreased gradually, and the process could be divided into a faster hydration process and a slower degradation process, which were fitted by the double exponential function model:

$$A = {A}_{1} {e}^{- {k}_{1} t} + {A}_{2} {e}^{- {k}_{2} t} + {A}_{0} , \qquad ( 1 )$$

where:
A was the absorbance at the maximum absorption wavelength; A₁ and A₂ were values of reduced absorbance due to hydration and degradation; k₁ and k₂ were rate constants due to hydration and degradation; t was the storage time; and A₀ was the absorbance of hydrated or degraded products.

As shown in Table 2, the color loss of the solution of anthocyanin alone was mainly attributed to hydration, accounting for 82.4% (calculated based on A₁/(A₁+A₂)). The color loss due to hydration was reduced to 40.3% after adding HSA. Since the hydration occurs faster than the degradation, the color can be remained longer by inhibiting the progress of hydration. In addition, after adding HSA, the rate constants for both processes were significantly reduced to about ½ of the group of anthocyanin alone, indicating that the addition of HSA significantly alleviated both color loss pathways of anthocyanins.

TABLE 2
Fitting parameters of anthocyanin degradation kinetics during storage

| Sample | A₁ | A₂ | k₁ (h⁻¹) | k₂ (h⁻¹) | A₀ |
|---|---|---|---|---|---|
| Anthocyanin | 0.305 ± 0.007 | 0.065 ± 0.005 | 0.632 ± 0.037 | 0.020 ± 0.004 | 0.0465 ± 0.004 |
| Anthocyanin + | 0.167 ± 0.006 | 0.247 ± 0.007 | 0.318 ± 0.034 | 0.009 ± 0.001 | 0.156 ± 0.010 |
| protein | | | | | |

### Example 3

In this example, the effects of the addition of human serum albumin (HSA) and bovine serum albumin (BSA) on the color of different kinds of anthocyanin solutions (cyanidin-3-glucoside (C3G)), pelargonidin-3-glucoside (P3G)), malvidin-3-glucoside (M3G)) were evaluated as follows:
(1) Solutions of C3G, P3G and M3G with a concentration of 5 mM were prepared in hydrochloric acid at pH of about 2, respectively. Solutions of HSA and BSA with a concentration of 0.2 mM were prepared in 20 mM MOPS buffer (pH 7.0), respectively.
(2) The above solutions were preheated to 25° C. 20 μL of each of the different anthocyanin solutions was mixed with 2 mL of the protein solution, and the pH value of the resulting mixed solution was 7.0. 20 μL of the anthocyanin solution and 2 mL of MOPS buffer were taken to mix well as the control group. The mixture stood at 25° C. for 60 min in the dark.

As shown in FIG. 6, the maximum absorption wavelengths (λₘₐₓ) of C3G, P3G and M3G solutions (0.05 mM) were 550, 532 and 572 nm, respectively, at which the solutions were all purple-red. The addition of 0.2 mM HSA resulted in a red shift of 58 nm, shifting the λₘₐₓ of the C3G solution to 608 nm, and the solution turned blue. The addition of 0.2 mM BSA had insignificant effect on the absorption spectrum of the C3G solution. The addition of BSA (0.2 mM) and HSA (0.2 mM) had insignificant effect on the absorption spectrum of the P3G solution, and the color change was not obvious. Even when the concentrations of BSA and HSA were adjusted to 1 mM, no significant color change was observed. The addition of HSA (0.2 mM) and BSA (0.2 mM) resulted in a red shift of 55 nm and 69 nm, respectively, shifting the λₘₐₓ of the M3G solution to 627 nm and 641 nm, respectively, and the solutions turned blue. At the same time, the absorbance of the solutions also increased with the addition of protein, indicating that the color of the solution was deepen.

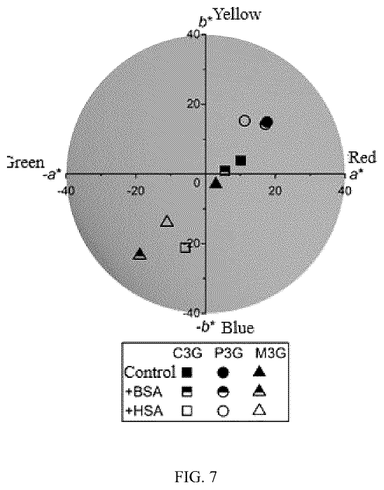

The color of the sample represented by the CIE Lab color model was calculated based on the visible absorption spectra, as shown in Table 3 and FIG. 7. After adding HSA in the C3G solution, and after adding HSA and BSA in the M3G solution, the color difference value was relatively great and the color change was more obvious when compared with the control group. Particular, the decrease of a* and b* was negative, reducing the contribution of red in the color. Thus, the solutions appeared blue.

TABLE 3
Representation of the CIE Lab color model for the
solution of different anthocyanins and the solutions
of anthocyanins added with different proteins

| | | | | |
|---|---|---|---|---|
| Group | L* | a* | b* | ΔE |

| | | | | | |
|---|---|---|---|---|---|
| C3G | Control | 79.41 | 10.16 | 3.85 | — |
| | +BSA | 79.42 | 5.55 | 0.84 | 5.50 |
| | +HSA | 49.28 | −5.84 | −21.15 | 42.29 |
| P3G | Control | 77.70 | 17.64 | 14.94 | — |
| | +BSA | 77.86 | 17.16 | 14.27 | 0.84 |
| | +HSA | 72.84 | 11.20 | 15.28 | 8.07 |
| M3G | Control | 67.23 | 2.96 | −2.91 | — |
| | +BSA | 57.33 | −18.85 | −23.34 | 31.48 |
| | +HSA | 60.18 | −11.07 | −13.95 | 19.19 |

In the specification, references to descriptions of the terms “an embodiment”, “some embodiments”, “examples”, “specific examples”, and “some examples”, etc. mean that a particular feature, structure, material, or characteristic described in connection with the embodiment or example is included in at least one embodiment or example of the present disclosure. In this specification, schematic representations of the above terms are not necessarily directed to the same embodiment or example. Furthermore, the particular features, structures, materials, or characteristics described may be combined in any suitable manner in any one or more embodiments or examples. Furthermore, combinations and combinations of the various embodiments or examples and features of the various embodiments or examples described in this specification can be made by those skilled in the art without departing from the scope of the present disclosure.

It can be understood that the embodiments of the present disclosure shown and described above are illustrative and are not intended to limit the present disclosure. Those skilled in the art, without departing from the scope of the present disclosure, can make changes, modifications, substitutions and alterations to the above-mentioned embodiments.

What is claimed is:

1. A method for bluing anthocyanin, comprising:
mixing anthocyanin with a protein to obtain a mixed solution; and
bluing the anthocyanin through standing treatment of the mixed solution.

2. The method of claim 1, comprising no high hydrostatic pressure treatment.

3. The method of claim 1, wherein a concentration of the anthocyanin in the mixed solution ranges from 0.05 mM to 0.2 mM.

4. The method of claim 1, wherein:
the anthocyanin is cyanidin-3-glucoside; and
the protein is selected from human serum albumin or lysozyme, a concentration of the human serum albumin, if present, in the mixed solution ranging from 0.1 mM to 2 mM, and a concentration of the lysozyme, if present, in the mixed solution ranging from 0.8 mM to 1.5 mM.

5. The method of claim 1, wherein:
the anthocyanin is malvidin-3-glucoside; and
the protein is selected from human serum albumin or bovine serum albumin, a concentration of the human serum albumin or the bovine serum albumin in the mixed solution ranging from 0.1 mM to 0.5 mM.

6. The method of claim 1, wherein a pH value of the mixed solution ranges from 5.0 to 9.0.

7. The method of claim 1, wherein:
the anthocyanin is cyanidin-3-glucoside; and
the protein is selected from human serum albumin or lysozyme, a concentration of the human serum albumin, if present, in the mixed solution ranging from 0.1 mM to 0.3 mM, and a concentration of the lysozyme, if present, in the mixed solution ranging from 0.9 mM to 1.2 mM.

8. The method of claim 1, wherein:
the anthocyanin is malvidin-3-glucoside; and
the protein is selected from human serum albumin or bovine serum albumin, a concentration of the human serum albumin or the bovine serum albumin in the mixed solution ranging from 0.1 mM to 0.3 mM.

9. The method of claim 1, wherein said mixing comprises:
mixing the anthocyanin and the protein in a buffer, wherein the buffer is selected from a phosphate buffer, a citrate buffer, a MOPS buffer, a Tris-HCl buffer, a CHES buffer, a MES buffer, or a HEPES buffer.

10. The method of claim 1, wherein the standing treatment comprises: standing at 0° C. to 40° C. for 10 minutes to 180 minutes in the dark.

11. A method for bluing anthocyanin, comprising:
mixing anthocyanin with a protein in a buffer solution with a pH value of 7.0, to obtain a mixed solution, wherein a concentration of the anthocyanin in the mixed solution is 0.05 mM; and
allowing the mixed solution to stand at 25° C. for 60 min in the dark, wherein:
the anthocyanin is cyanidin-3-glucoside, the protein is selected from human serum albumin or lysozyme, a concentration of the human serum albumin, if present, in the mixed solution is 0.2 mM, and a concentration of the lysozyme, if present, in the mixed solution is 1 mM; or
the anthocyanin is malvidin-3-glucoside, the protein is selected from human serum albumin or bovine serum albumin, and a concentration of the human serum albumin or the bovine serum albumin in the mixed solution is 0.2 mM.

12. A method for preparing an anthocyanin product, comprising the method for bluing anthocyanin of claim 1.
